(19) United States
(12) Patent Application Publication
(10) Pub. No.: US 2018/0034165 A1
(43) Pub. Date: Feb. 1, 2018

(54) MINIATURIZED DUAL-POLARIZED BASE STATION ANTENNA

(71) Applicant: Zimeng LI, Dongguan (CN)

(72) Inventors: Sledkov Victor Aleksandrovich, Guangzhou (CN); Zimeng LI, Dongguan (CN)

(21) Appl. No.: 15/225,749

(22) Filed: Aug. 1, 2016

Related U.S. Application Data
(63) Continuation-in-part of application No. 15/023,557, filed on Mar. 21, 2016.

(51) Int. Cl. H01Q 21/26; H01Q 9/26; H01Q 1/48; H01Q 1/24; H01Q 5/392

(52) U.S. Cl. CPC H01Q 21/26; H01Q 1/246; H01Q 5/392; H01Q 1/48; H01Q 9/26

(57) ABSTRACT

A dual polarized antenna comprises the radiating arrangement and a feeding element containing two coaxial cables and two supporting conductors forming two perpendicular baluns supporting the radiating arrangement above a ground plate. The radiating arrangement comprises four crossed dipoles feeding by four symmetrical lines from the center of the radiating arrangement. Adjacent conductors of symmetrical lines connected together at the center of the radiating arrangement. Top ends of outer conductors of coaxial cables and top ends of supporting conductors are connected to adjacent conductors of symmetrical lines at the center of the radiating arrangement. Bottom ends of outer conductors of coaxial cables and bottom ends of supporting conductors are connected to a base plate. Length of supporting conductors is less than 0.15 wave length corresponding to the middle operating frequency. Inner conductors of coaxial cables are connected to supporting conductors by bridges placed above radiating arrangement.

### CROSS-REFERENCE TO RELATED APPLICATION

This application is a continuation-in-part of U.S. application Ser. No. 15/023,557 filed on Mar. 21, 2016.

### FIELD OF THE INVENTION

The present invention relates to dual polarized directional antennas emitting or receiving two orthogonal polarizations such as vertical and horizontal or two 45 degrees slants polarizations. The invention describes a dual polarized antenna having 55-75 degree half power beam width.

### BACKGROUND OF THE INVENTION

One of the first dual polarized antennas is described in U.S. Pat. No. 3,740,754, wherein two dipoles made of metal tubes are disposed at right angles to each other above a reflecting cap and fed by two pairs of coaxial lines. Subsequently, hundreds of different dual polarized antennas were invented to increase operating frequency band.

U.S. Pat. No. 4,184,163 describes a broad band dual polarized antenna wherein dipole arms are made of metal loops having a ring or square frame. U.S. Pat. No. 5,481,272, U.S. Pat. No. 5,952,983, U.S. Pat. No. 6,028,563 and U.S. Pat. No. 6,072,439 describe several types of dipoles including folded grid dipoles, bow tie dipoles, and dipoles with an attached printed circuit board balun.

Several kinds of crossed dipoles containing radiating arms formed of two branches to decrease beam width are described in U.S. Pat. No. 6,747,606B2, US2005/0253769A1, US2013/0106668A1, CN201435451Y, CN102025023A, CN201845867U and CN102074781A.

As crossed dipoles create a wide beam at the horizontal (H) plane, more complicated radiators were invented to decrease beam width. U.S. Pat. No. 5,940,044 describes a dual slant polarized antenna having approximately 65 degrees half power beam width in the horizontal plane. This antenna includes a plurality of dipole sub-arrays with each sub-array comprising four dipoles arranged in a diamond shape. Two dipoles of each sub-array are tilted at an angle of +45 degrees from the long edge of the ground plate to form a +45 degree polarized radiating element array. The other two dipoles are arranged at an angle −45 degrees from the long edge of the ground plate to form a −45 degree polarized radiating element array. The dipoles are arranged such that the phase centers of one +45 degree dipole and one −45 degree element line up along a first vertical line which is parallel to the long edge of a ground plate. The phase centers of the other +45 degree dipole and −45 degree element line up along a second vertical line. The main disadvantage of this dipole square is the complicated feed network. For example, four cables have to be used for feeding the dipoles.

EP0973231A2, U.S. Pat. No. 6,333,720B1, U.S. Pat. No. 6,529,172B2 and US2010/0309084A1 describe radiators having a dipole square shape. Baluns of the same dipoles are tilted to the center of the dipole square to simplify manufacturing. In spite of this new shape, these devices are still complicated.

U.S. Pat. No. 6,313,809B1 describes a dual polarized radiator comprising four dipoles preferably arranged above a reflector and forming a dipole square structurally in the top view. Each dipole is fed by means of a symmetrical line characterized by the following features. The radiator radiates electrically in polarizations at an angle of +45 or −45 degrees to the structurally prescribed alignment of dipoles. The ends of symmetrical lines leading to the respective dipole halves are connected in such a way that the corresponding line halves of the adjacent, mutually perpendicular dipole halves are always electrically connected. The electric feeding of the respectively diametrically opposite dipole halves is performed in a decoupled fashion for a first polarization and a second polarization orthogonal thereto.

Other modifications of this dipole square are described in U.S. Pat. No. 6,940,465B2, U.S. Pat. No. 7,688,271B2, CN202423543U, CN202268481U, CN101916910A, CN102097677A, CN102694237A, CN102544711A, CN201199545Y, CN102117967A and CN102013560A. WO2007/114620A1 describes a dual polarized radiator comprising four folded dipoles preferably arranged in the same way as dipoles of the radiator described in U.S. Pat. No. 6,313,809B1. Other modifications of a dipole square formed by four folded dipoles are described in CN101707292A, CN201430215Y, CN202178382U, and CN202004160U. Folded dipoles coupled with a dipole square by capacitive coupling are described in CN102377007A, CN201117803Y, CN201117803Y and CN101505007A.

Known radiators containing four usual or folded dipoles arranged as a dipole square provide good patterns at a frequency band up to 30% but need a wide ground plate to provide a good front to back ratio. Its radiating arrangements are placed above a ground plate on a distance about 0.25 wave length corresponding to the middle operating frequency therefore known radiators have big dimensions.

To overcome this disadvantage, many other dual polarized radiators having smaller dimensions were invented. Crossed dipoles having different kinds of dipole arms are described in U.S. Pat. No. 6,933,906B2, U.S. Pat. No. 7,132,995B2, US2012/0235873 A1, CN102074779A, CN102157783A, CN101707291A, CN101572346A, CN201741796U, CN101546863A, CN101673881A, CN202150554U, CN102246352A, CN102484321A, CN202423541U, CN102544764A and CN101707287A. At the H plane, a beam of crossed dipoles is too wide. Therefore, big side walls are used to reduce a beam width as shown, for example, in U.S. Pat. No. 7,679,576B2.

Folded dipoles formed by a connective portion and connected to oscillator arms act as a dipole square, as described in WO 2007/114620A1.

The dual polarization broadband antenna having a radiating arrangement containing four folded dipoles is described in US2009/0179814 A1, and one such radiator is shown in FIG. 1 as the prior art.

### SUMMARY OF THE INVENTION

Modern wireless communication systems need high quality antennas having small dimensions and providing high quality patterns having big cross polarization ratio and big front to back ratio. Known dual polarized antennas contain wide ground plates to provide big front to back ratio therefore ones have big dimensions. The first objective of the invention is to decrease dimensions of an antenna. The second objective of the invention is to create a small antenna having the same cross polarization ratio and front to back ratio as known antennas having big dimensions. The third objective of the invention is to create a small antenna having a good matching with feeding cables.

The invention provides a dual polarized antenna including the radiating arrangement and conductive members supporting the radiating arrangement above a ground plate and forming two perpendicular baluns. The radiating arrangement excited by two coaxial cables placed in the middle of the radiating arrangement radiates two mutually perpendicular linear electrical fields having E vectors directed parallel to the diagonals of the radiating arrangement.

The present invention describes the radiating arrangement containing four folded dipoles feeding by four symmetrical lines. Adjacent conductors of symmetrical lines are connected together in the middle of the radiating arrangement.

A ground plate of the present invention is smaller than a ground plate of known antennas. The radiating arrangement of the present invention is placed on a smaller distance above a ground plate than radiating arrangements of known antennas and contains additional conductors placed between ends of folded dipoles and above its middle part. These conductors improve front to back ratio and cross polarization ratio and match the radiating arrangement with feeding coaxial cables.

### BRIEF DESCRIPTION OF THE DRAWINGS

The accompanying drawings, which are incorporated in and constitute part of the specification, illustrate embodiments of the invention and, together with the general description of the invention given below, serve to explain the principles of the invention.

FIG. 1 is a dual polarized broadband antenna from the prior art (US2009/0179814 A1), having a radiating arrangement containing four folded dipoles feeding by four symmetrical lines connected together at center of a radiating arrangement;

FIG. 2 shows the first embodiment of the present invention containing a radiating arrangement made as printed circuit board and additional conductors placed above a ground plate on a perspective view;

FIG. 3 shows the bottom surface of a radiating arrangement with two supporting conductors and two feeding coaxial cables connected to a base plate;

FIG. 4 shows the top view of the radiating arrangement without a top metal plate;

FIG. 5 shows the second embodiment of the present invention where a radiating arrangement and two perpendicular baluns made as one part by die-casting on a perspective view;

FIG. 6 shows the third embodiment of the present invention where a radiating arrangement and two perpendicular baluns made as one part by die-casting on a perspective view; and

FIG. 7 shows the other embodiment of the present invention containing a radiating arrangement made as printed circuit board, and one PCB patch as top conductor and supports above dipoles on a perspective view.

### DETAILED DESCRIPTION OF THE PREFERRED EMBODIMENTS

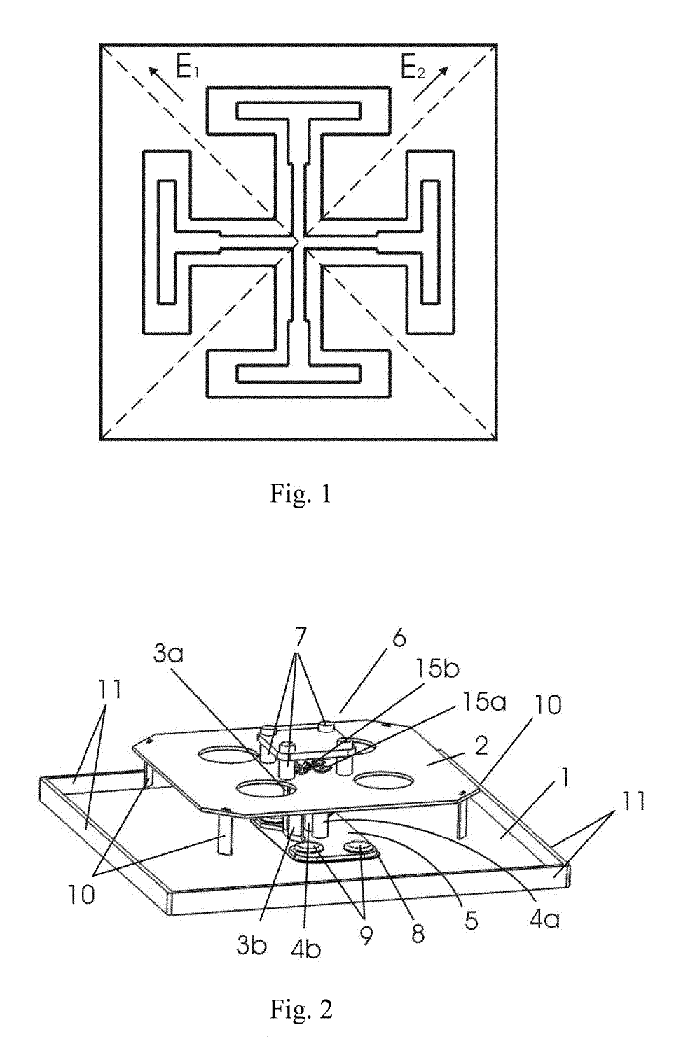

FIG. 1 is a dual polarized broadband antenna from the prior art (US2009/0179814 A1), having a radiating arrangement containing four folded dipoles feeding by four symmetrical lines. Adjacent conductors of symmetrical lines connected together at the center of the radiating arrangement. This antenna excited by two coaxial cables placed in the middle of the radiating arrangement radiates two mutually perpendicular linear electrical fields having E vectors directed parallel to the diagonals of the radiating arrangement.

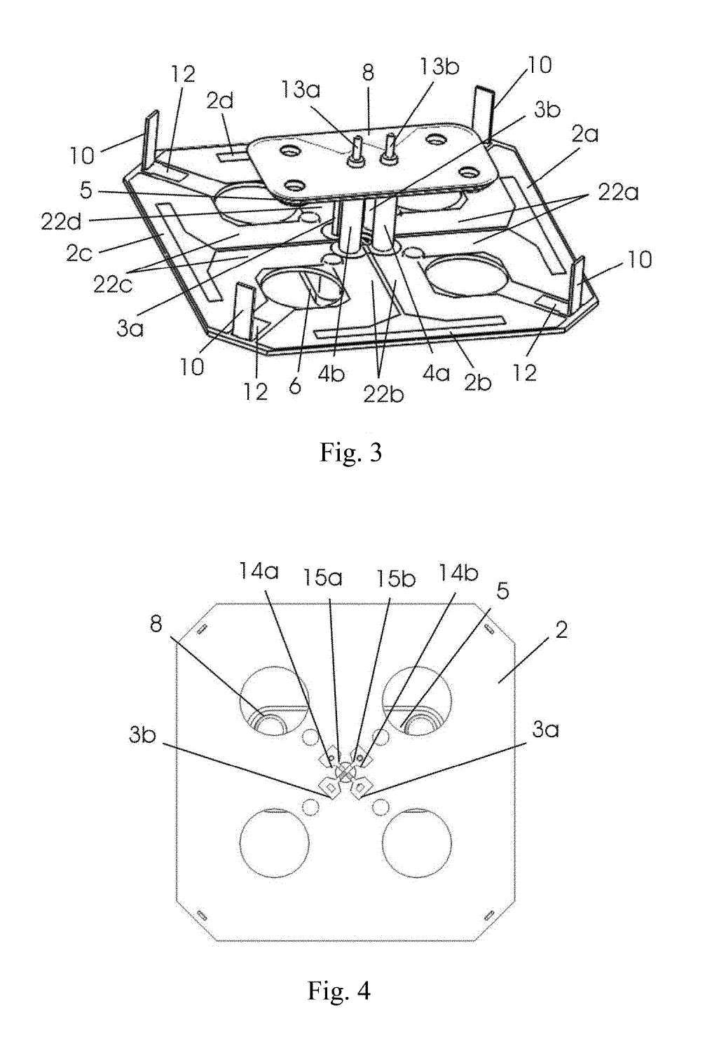

FIG. 2 shows the first embodiment of the present invention containing a radiating arrangement made as a printed board circuit and supported by two perpendicular baluns above a ground plate 1 on a perspective view. A ground plate 1 has smaller dimensions than ground plates of known antennas. Four folded dipoles 2a, 2b, 2c and 2d feeding by four symmetrical lines 22a, 22b, 22c and 22d are placed on a bottom surface of a dielectric substrate 2 shown on FIG. 3. The first balun is formed by supporting conductor 3a and outer conductor 4a of a coaxial cable connected to base plate 5. The second balun is formed by supporting conductor 3b and outer conductor 4b of a coaxial cable connected to a base conductive plate 5. The length of supporting conductor 3a and 3b is less than 0.15 wave length corresponding to the middle operating frequency. Bottom ends of supporting conductor 3a, 3b and bottom ends of outer conductor 4a, 4b are connected to a base 5. A top conductive plate 6 is supported by dielectric spacers 7 above a dielectric substrate 2. A base 5 is separated from a ground plate 1 by an insulating dielectric film 8 and fixed to a ground plate by plastic rivets 9. An insulating dielectric film 8 provides only capacitive coupling between a base plate 5 and a ground plate 1. Therefore this embodiment does not produce passive inter-modulation products created by metal to metal junctions.

Conductors 10 are placed at corners of a substrate 2 and directed to a ground plate 1. Side walls 11 are placed at edges of a substrate 2.

FIG. 3 shows the bottom surface of a dielectric substrate 2 containing four folded dipoles 2a, 2b, 2c and 2d fed by four symmetrical lines 22a, 22b, 22c and 22d respectively. Four conductors 12 are placed on the bottom surface of a dielectric substrate 2 between ends of folded dipoles. Each conductor 12 is connected to one of conductors 10.

Top end of supporting conductor 3a is connected to adjacent conductors of symmetrical lines 22c and 22d. Top end of supporting conductor 3b is connected to adjacent conductors of symmetrical lines 22a and 22d. Top end of outer conductor of coaxial cable 4a is connected to adjacent conductors of symmetrical lines 22a and 22b. Top end of outer conductor of coaxial cable 4b is connected to adjacent conductors of symmetrical lines 22b and 22d.

FIG. 4 shows the top view of a dielectric substrate 2 without a top conductive plate 6. Inner conductors 14a and 14b of coaxial cables 4a and 4b are connected to top ends of supporting conductors 3a and 3b by conductive bridges 15a and 15b respectively.

Conductors 10 have capacitive coupling with ends of folded dipoles and with a ground plate 1 therefore RF currents flows along conductors 10 and creates radiation directed along a ground plate with E vectors directed perpendicular to a ground plate. This radiation increases beam width in E plane and partly suppress radiation from folded dipole in back direction. Conductors 12 connected to conductors 10 increase capacitive coupling of conductors 10 with ends of folded dipoles. Thus conductors 10 and 12 increase front to back ratio of an antenna and create radiation with E vectors directed perpendicular to a ground plate. This radiation increases cross polarization ratio at the edges of +/−60 degree sector. As a result an antenna with a small ground plate has the same front to back ratio and cross polarization ratio at the edges of +/−60 degree sector as known antennas having a big ground plate.

Conductive bridges 15a and 15b excite a top conductive plate 6. Dimensions of a top conductive plate 6 are smaller than dimensions of folded dipoles therefore one radiates at high frequencies of operating frequency band. Phase of radiation from a top conductive plate 6 is different from phase of radiation from folded dipoles since ones are excited by ends of symmetrical lines. At high frequencies of operating frequency band difference between phases is enough to partly suppress radiation from folded dipoles. Therefore radiation from a top conductive plate 6 increase beam width of an antenna at high frequencies of operating frequency band. As a result beam width of an antenna having a distance between dipoles and a ground plate less than 0.15 wave length corresponding to the middle operating frequency has the same dependence versus frequency known antennas having this distance about 0.25 wave length corresponding to the middle operating frequency.

A top conductive plate 6 together with conductors 10 and 12 create reflection partly suppressing reflection from folded dipoles. As a result an antenna having a distance between dipoles and a ground plate less than 0.15 wave length corresponding to the middle operating frequency has the same matching width feeding cables as known antennas having this distance about 0.25 wave length corresponding to the middle operating frequency.

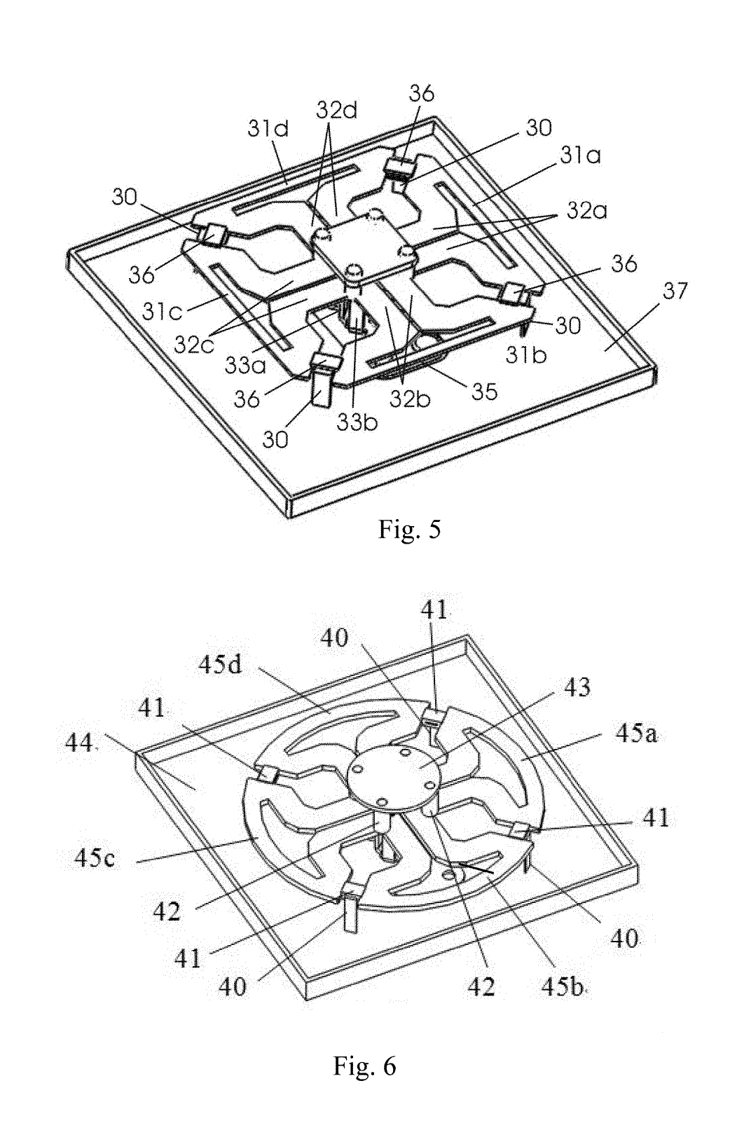

FIG. 5 shows the second embodiment of the present invention where a radiating arrangement including folded dipoles 31a, 31b, 31c and 31d connected with symmetrical lines 32a, 32b 32c and 32d and two perpendicular baluns made as one part by die-casting on a perspective view. The first balun is formed by supporting conductor 33a and outer conductor 34a of a coaxial cable connected to base plate 35. The second balun is formed by supporting conductor 33b and outer conductor 34b of a coaxial cable connected to base plate 35.

Conductors 30 are supported between ends of folded dipoles by dielectric spacers 36. Each conductor 30 is bent at right angle. One its part is placed in dielectric spacers 36 and other part directed towards a ground plate 37 therefore conductor 30 acts as conductors 10 and 12 in FIG. 4.

The second embodiment of the present invention shown in FIG. 5 provides the same advantages as the first embodiment but cheaper for manufacturing and can radiate more power.

FIG. 6 shows the other embodiment of the present invention where a radiating arrangement including folded dipoles 45a, 45b, 45c and 45d, connected with symmetrical lines and two perpendicular baluns made as one part by die-casting on a perspective view. This dipole structure show on circle shape, A top conductive plate 43 is supported by dielectric spacers 42 above a radiating arrangement. Conductors 40 are supported between ends of folded dipoles by dielectric spacers 41. Each conductor 40 is bent at right angle. One its part is placed in dielectric spacers 41 and other part directed towards a ground plate 44 therefore conductor 40 acts as conductors 10 and 12 in FIG. 4. also, The embodiment of the present invention shown in FIG. 6 provides the same advantages as FIG. 5.

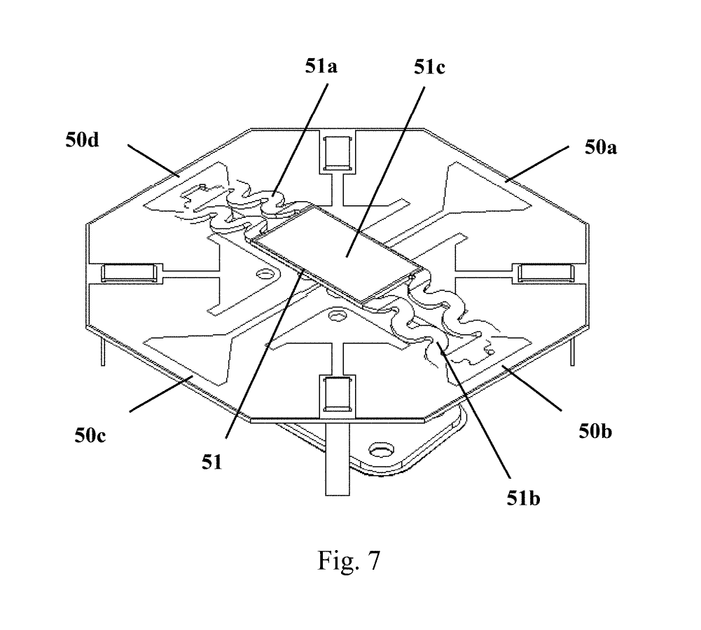

FIG. 7 shows the other embodiment of the present invention where a radiating arrangement including folded dipoles 50a, 50b, 50c and 50d, connected with symmetrical lines and two perpendicular baluns. This dipole structure show the similar with the first embodiment of the present invention, but a top conductive plate (PCB patch) 51 is different with the first embodiment of the present invention, the top conductive plate 51 is made up of 51a, 51b, 51c as one PCB part, the curve 51a and 51b without copper on FR4 curve, they are supports for 51c part, 51c is PCB, we can change the shape of 51c according to our design for matching, it is very flexible for our matching in development, top conductive plate 51 as one parts is better than others, it is good for assembly, and decrease the assembling time in MP. And reduce the cost.

A sample of the dual polarized antenna was designed according to the invention for 1710 to 2200 MHz frequency band. Folded dipoles were paced on dielectric substrate placed on distance 20 mm only above a ground plate having dimensions 120×120 mm. This antenna has 60-68 degree half power beam width and VSWR better than 1.2. A sample of a +/−45 degree slant polarization antenna array containing four this antennas has cross section 45×120 mm only. In the 1710 to 2200 MHz frequency band this array has front to back ratio better than −28 dB for co-polarization and better than −27 dB for cross polarization. Its cross polarization ratio is better than −25 dB at the main direction and −10 dB at the edges of +/−60 degree sector and VSWR better than 1.25.

Thus the present invention provides a small antenna having the same specification as known antennas having bigger dimensions.

What is claimed is:

1. A dual polarized antenna comprising:
the radiating arrangement; and the feeding element containing two coaxial cables and two supporting conductors forming two perpendicular baluns supporting the radiating arrangement above a ground plate;
wherein the radiating arrangement comprises four folded dipoles feeding by four symmetrical lines from the center of the radiating arrangement;
wherein distance between the radiating arrangement and a ground plate is less than 0.15 wave length corresponding to the middle operating frequency;
wherein adjacent conductors of symmetrical lines connected together at the center of the radiating arrangement;
wherein top ends of outer conductors of coaxial cables and top ends of supporting conductors are connected to adjacent conductors of symmetrical lines at the center of the radiating arrangement;
wherein bottom ends of outer conductors of coaxial cables and bottom ends of supporting conductors are connected to a base plate;
wherein inner conductors of coaxial cables are connected to supporting conductors by conductive bridges placed above radiating arrangement;
wherein four conductors are placed between ends of adjacent folded dipoles and connected with other four conductors placed between radiating arrangement and a ground plate;
wherein a top conductive plate is placed above a middle portion of a radiating arrangement.

2. The dual polarized antenna according to claim 1, wherein the radiating arrangement and conductors placed between ends of adjacent folded dipoles are made as a printed board circuit.

3. The dual polarized antenna according to claim 1, wherein the radiating arrangement and two perpendicular baluns are made as one part by die-casting. and is shown square shape or circle shape.

4. The dual polarized antenna according to claim 1, wherein a top conductive plate is supported above a middle portion of the radiating arrangement by dielectric spacers.

5. The dual polarized antenna according to claim 1, wherein a top conductive plate has a square or circle shape.

6. The dual polarized antenna according to claim 1, wherein a top conductive plate and dielectric spacers are made by a block PCB as one part.

7. The dual polarized antenna according to claim 1, wherein a base plate is separated from a ground plate by an insulating dielectric film.

8. The dual polarized antenna according to claim 1, wherein a ground plate has side walls.

9. The dual polarized antenna according to claim 1, wherein conductor placed between ends of adjacent folded dipoles and conductor placed between the radiating arrangement and a ground plate are made as one bent metal strip supported by a dielectric spacer.

10. The dual polarized antenna according to claim 3, wherein conductor placed between ends of adjacent folded dipoles and conductor placed between the radiating arrangement and a ground plate are made as one bent metal strip supported by a dielectric spacer.
